(19) United States
(12) Patent Application Publication
(10) Pub. No.: US 2005/0217267 A1
(43) Pub. Date: Oct. 6, 2005

(54) Air pump having valve controlled by self-pressure

(75) Inventors: Kunihiro Tsuzuki, Obu-city (JP); Shinichi Yokoyama, Gifu-city (JP); Akikazu Uchida, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/095,609

(22) Filed: Apr. 1, 2005

(30) Foreign Application Priority Data
Apr. 2, 2004 (JP) 2004-109947

(51) Int. Cl. F02B 33/44; F25J 1/00

(52) U.S. Cl. 60/606; 60/608

(57) ABSTRACT

A pump unit (14) has an air pump and a valve device, wherein the valve device has a pressure chamber and a pressure control device, so that the air from the air pump is introduced into the pressure chamber and the pressure in the pressure chamber is controlled by the pressure control device. The pump unit has an outlet port, an opening of which is controlled by a valve body driven by a diaphragm, so that the amount of the air to be supplied through the outlet port is controlled by the pressure of the pressure chamber.

### CROSS REFERENCE TO RELATED APPLICATION

This application is based on Japanese Patent Application No. 2004-109947 filed on Apr. 2, 2004, the disclosure of which is incorporated herein by reference.

### FIELD OF THE INVENTION

This invention relates to an air supply pump having a valve, an opening of which is controlled by pressure of fluid discharged by the air pump. In particular, this invention relates to an electric air pump of a secondary air supply system for a vehicle, for supplying the air into an exhaust pipe of an engine at an upstream side of a catalyst, which purifies the exhaust gas.

### BACKGROUND OF THE INVENTION

A conventional secondary air supply system is known in the art, for example as disclosed in Japanese Patent Publication H11-81998, in which air is supplied by an air pump into an exhaust pipe of an engine at an upstream of a catalyst for purifying exhaust gas, so that the warm-up of the catalyst is facilitated. The air pump of the system has a valve device for controlling an opening of an air passage for the secondary air, in which the opening is controlled by the air pressure generated by the air pump. The valve is called as a self-pressure control valve.

In the above Japanese Patent Publication, an air switching valve (ASV) is disclosed. The air switching valve opens and closes a secondary air passage communicated with an exhaust pipe of an engine at an upstream side of a catalyst, wherein a discharge pressure of the air pumped out from an electric air pump is applied to a pressure chamber, a diaphragm forming a part of the pressure chamber is displaced by the air pressure, and the displacement of the diaphragm is transmitted to the valve.

In the conventional air pump system having the self-pressure control valve, the diaphragm is displaced by the air pressure generated by the air pump and the valve is opened or closed by the displacement of the diaphragm, and thereby the valve is automatically opened when the air pump starts its operation or the valve is automatically closed when the operation of the air pump is stopped.

In other words, in the conventional air pump system, the valve can not be closed so long as the air pump is operating, whereas the valve can not be kept opened after the operation of the air pump is stopped.

Furthermore, an opening degree of the valve can not be controlled in the conventional system, since the valve is driven by the displacement of the diaphragm which is decided by the discharge amount of the air pump. Namely, the amount of the air is controlled by not the opening degree of the valve, but the discharge amount of the air pump.

The same problem occurs in the air supply system, in which a mechanical type air pump is used.

### SUMMARY OF THE INVENTION

The present invention is made in view of the above problems, and it is an object of the present invention to provide an air supply pump system which has the following features:
(1) a valve device can keep its closed position, even during an air supply pump is operating;
(2) the valve device can keep its opened position, even after the air supply pump has stopped its operation; and
(3) an opening degree of the valve device can be controlled at a desired position. Namely the amount of the air to be supplied can be controlled independently from the amount of the discharged air from the air supply pump.

According to a feature of the present invention, a pump unit (14) for an air supply pump system has an air pump (12) for compressing and discharging air and a valve device (13) for controlling the air to be supplied to, for example, an exhaust pipe of an engine. The valve device (13) has a pressure chamber (44) into which the compressed high-pressure air from the air pump (12) is introduced, a diaphragm (46) moving in response to the pressure in the pressure chamber (44), and a valve body (43) operatively connected to the diaphragm (46) for controlling an opening or closing of an outlet port (42) of the valve device. The pump unit (14) further has a communication passage (52) for introducing the compressed high-pressure air from the air pump (12) into the pressure chamber (44), and a pressure control device (53) provided in the communication passage (52) for controlling the pressure in the pressure chamber (44) by controlling an opening and closing of the communication passage (52).

According to another feature of the present invention, the pressure control device (53) comprises a two-way valve or a three-way valve, for controlling the pressure in the pressure chamber (44).

According to a further feature of the present invention, the pump unit has an inside passage (61) for connecting a discharge port (51) of the air supply pump (12) with the outlet port (42), and the pressure chamber (44) is operatively communicated with the inside passage (61) through the communication passage (52). The volume of the inside passage (61) is designed to be small, so that the quick response of the opening and closing of the outlet port (42) can be achieved.

According to a still further feature of the present invention, a pressure sensor (62) is provided in the inside passage (61) for detecting the pressure therein, so that the operational condition of the air supply pump (12) and/or the valve device (13) can be diagnosed.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of a secondary air supply system for an internal combustion engine, according to an embodiment of the present invention; and

FIG. 2 is an enlarged cross sectional view of a pump unit shown in FIG. 1.

### DETAILED DESCRIPTION OF THE PREFERRED EMBODIMENTS

### First Embodiment

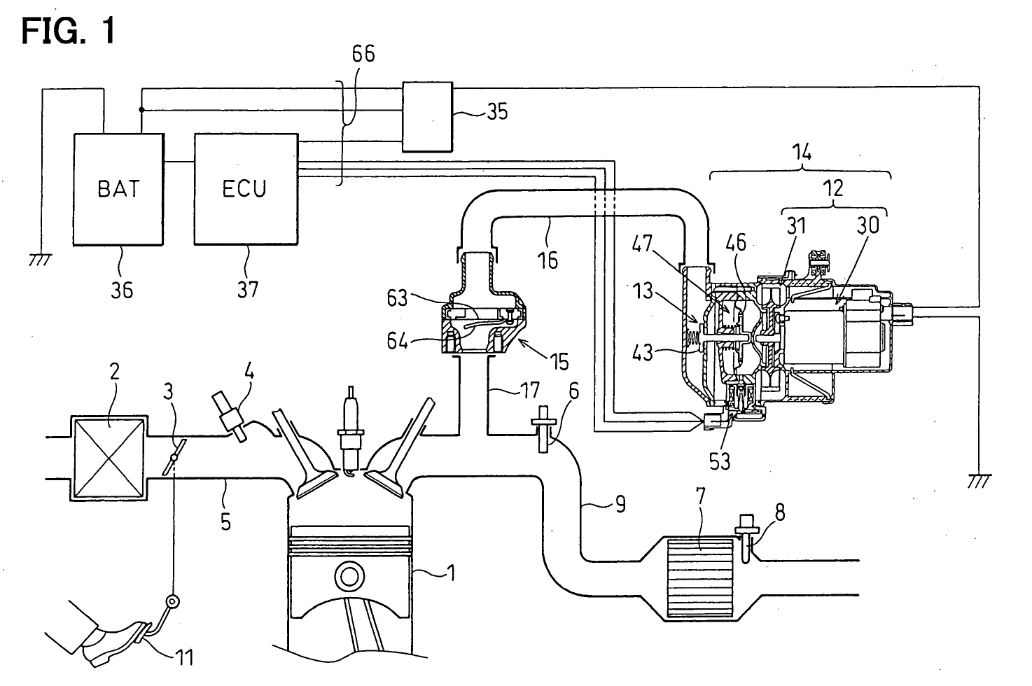

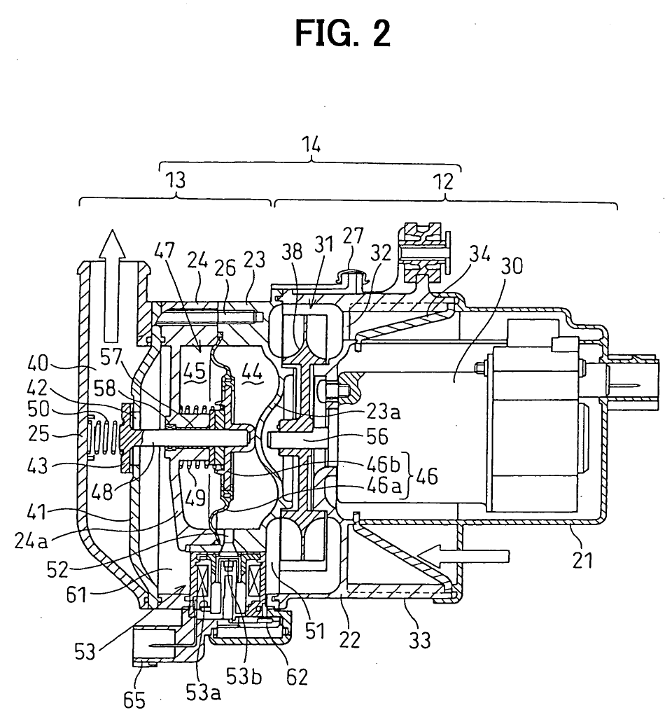

The present invention will be explained below with reference to the embodiment, in which the present invention is applied to a secondary air supply system for an internal combustion engine, as shown in FIGS. 1 and 2.

(Secondary Air Supply System)

In FIG. 1, a numeral 1 designates a well known internal combustion engine, which has an intake pipe 5 to which an air cleaner 2, a throttle valve 3, an injector 4 and so on are provided, and an exhaust pipe 9 to which an oxygen (O2) sensor 6, a catalyst 7 a temperature sensor 8 for the catalyst and so on are provided.

An opening degree of the throttle valve 3 is controlled by a press stroke of an acceleration pedal 11 operated by a vehicle driver. The catalyst 7 facilitates oxidation-reduction of exhaust gas to purify the exhaust gas.

The secondary air supply system has its major object to forcibly supply a secondary air into the exhaust pipe 9 at an upstream side of the catalyst 7, to facilitate an warming-up operation of the catalyst 7 during a cold-start period of the engine 1 The secondary air supply system comprises a pump unit 14, which is integrally formed by an electrical air pump 12 (a discharge pump) and a valve device 13 (an opening and closing of which is controlled by the air pressure from the air pump). The system further comprises a check valve 15 for preventing a reversed flow of exhaust gas, a first pipe 16 for connecting the pump unit 14 with the check valve 15, and a second pipe 17 for connecting the check valve 15 with the exhaust pipe 9.

(Pump Unit)

As shown in FIG. 2, the pump unit 14 comprises five casings 21 to 25, which are firmly assembled and fixed to each other by screws 26, clips 27 and other well known fixing means.

The electric air pump 12 comprises an electric motor 30 and a blower 31. The electric motor 30 is housed in the first and second casings 21 and 22. An annular air duct 33 is formed in the first and second casings 21 and 22 for guiding the air to a suction port 32 of the blower 31, and a filter 34 is arranged in the air duct 33 for filtering the air to be sucked into the blower 31.

The electric motor 30 of the embodiment is a DC motor and operatively connected to a battery 36 of a vehicle through a mechanical relay (a coil-type relay) 35, so that the electric motor 30 is operated when it is electrically connected to the battery 36 via the relay 35.

The mechanical type relay 35 comprises a relay coil, current supply to which is controlled by ECU (Engine Control Unit) 37, and a relay switch operated by electromagnetic force of the relay coil to open or close contacts, to electrically connect or disconnect the electric motor 30 to or from the battery 36.

Although in the embodiment shown in FIG. 1, the mechanical type relay 35 is arranged at an outside of the pump unit 14, the relay 35 can be arranged in the air duct 33 so that temperature increase of the relay 35 can be suppressed by the air to be sucked into the blower 31.

The blower 31 is of a double-blades vortex flow type and comprises an impeller 38 driven by the electric motor 30 for discharging the air under pressure, and a blower housing formed by the second and third casings 22 and 23.

(Valve Device)

The valve device 13 opens or closes a secondary air passage 40 by pressure of the air (secondary air) discharged from the blower 31, wherein the secondary air is supplied to the exhaust pipe 9 through the secondary air passage 40.

The valve device 13 comprises a valve seat element 41 and a valve body 43 for opening and closing an opening 42 (an outlet port of the pump unit) formed in the valve seat element 41.

A movable device, for displacing the valve body 43 by the discharged pressure of the blower 31, comprises a diaphragm device 47 and a shat 48. The diaphragm device 47 has a diaphragm 46 to be displaced by a pressure difference between a pressure chamber 44 (a diaphragm chamber) to which the discharged pressure of the blower 31 is introduced and an ambient air chamber 45 to which the ambient air is introduced. The shaft 48 is connected to the diaphragm 46 and the valve body 43 for transmitting the displacement of the diaphragm 46 to the valve body 43. Although in this embodiment, the shaft 48 and the valve body 43 are integrally formed as one piece, they can be separately manufactured and assembled together.

The diaphragm 46 of the diaphragm device 47, which is interposed between the third and fourth casings 23 and 24, divides a space formed by the third and fourth casings 23 and 24 into the pressure chamber 44 on a side of the electric air pump 12 and the ambient air chamber 45 communicated to the outside of the pump unit 14. The circular diaphragm 46 and the circular impeller 38 are closely arranged to oppose to each other, wherein a partitioning wall 23a of the third casing 23 is arranged between both of them.

The diaphragm 46 comprises a ring-shaped rubber element 46a, which is easily and elastically deformed, and a metal plate 46b provided (fixed to) at an inside of the rubber element 46a, wherein one end of the shaft 48 is connected to a center of the metal plate 46b.

A spring 49 is arranged in the ambient air chamber 45 for pressing the metal plate 46b in a direction to reduce a volume of the pressure chamber 44. Another spring 50 is arranged in the secondary air passage 40 for pressing the valve body 43 toward the opening 42 (the outlet port of the pump unit) to close the same.

The pressure chamber 44 is formed on the other side of the portioning wall 23a of the third casing 23, and adjacent to the impeller 38 and a discharge port 51 of the blower 31.

The pressure chamber 44 is operatively communicated to the discharge port 51 through a communication port 52, at which a pressure control device 53 is provided for opening and closing the communication port 52.

The pressure control device 53 is of a two-way valve to be electrically controlled to open and close the communication port 52. In this embodiment, the pressure control device 53 is a normally closed electromagnetic valve comprising a linear solenoid 53a and a valve 53b, wherein the supply of the electric power to the linear solenoid 53a is controlled by the ECU 37 and the valve 53b is operated by the linear solenoid 53a.

When the communication port 52 is opened by the pressure control device 53, the discharge port 51 of the blower 31 is communicated with the pressure chamber 44 through the communication port 52. Accordingly, when the pressure control device 53 opens the communication port 52 and the electric air pump 12 starts its operation, the discharge pressure of the blower 31 is applied to the pressure chamber 44 through the communication port 52 to increase the inside pressure of the pressure chamber 44.

The shaft 48 is arranged coaxially with a rotational shaft 56 of the electric motor 30, and movingly supported by a bush (a slide bearing) 57 in an axial direction, wherein the bush 57 is held by a wall 24a of the fourth casing 24.

On a left side of the bush 57, in FIG. 2, an oil seal 58 is provided to prevent an oil component included in the exhaust gas from adhering to the bush 57, when the exhaust gas comes to be mixed with the secondary air in the secondary air passage 40. With such an arrangement, the shaft 48 is prevented from being firmly fixed to the bush 57 by the oil component of the exhaust gas, even when the exhaust gas comes into the pump unit 14.

The valve seat element 41 is held between the fourth and fifth casings 24 and 25, and the opening 42 (the outlet port) formed in the valve seat element 41 is arranged coaxially with the rotational shaft 56 of the electric motor 30.

The valve body 43 is formed at the other end of the shaft 48. When the valve body 43 is seated on a valve seat, which is a periphery of the opening 42 on a downstream side of the air supply pump (the left side in FIG. 2), the opening 42 is closed.

The valve body 43 is provided adjacent to the diaphragm 46 via the shaft 48, and an inside passage 61 having a small volume and communicating the discharge port 51 of the blower 31 with the opening 42 is formed.

Since the volume of the inside passage 61 is designed to be smaller, the pressure in the inside passage 61 and the pressure in the pressure chamber 44 can be quickly increased shortly after the electric air pump 12 starts its operation.

A pressure sensor 62 is provided in the pressure control device 53 for detecting the pressure of the inside passage 61. An operational condition of the electric air pump 12 and/or the valve device 13 can be detected by the pressure sensor 62. Namely, the following cases can be detected:
(1) a normal operation of the electric air pump 12 can be detected, when the pressure of the inside passage 61 is between a first and a second predetermined values (the second predetermined value is higher than the first one.);
(2) an abnormal condition (e.g. non operation) of the electric air pump 12 can be detected, when the pressure of the inside passage 61 is lower than the first predetermined value; and
(3) an abnormal condition (a malfunction of opening operation) of the valve device 13 can be detected, when the pressure of the inside passage 61 is higher than the second predetermined value.

Furthermore, the pressure variation of the discharge pressure of the electric air pump 12, during an initial period shortly after the start of the operation of the electric air pump 12, can be precisely detected by the pressure sensor 62, since the volume of the inside passage 61 is designed to be smaller, as described above.

(Check Valve)

The check valve 15 prevents the exhaust gas from reversely flowing from the exhaust pipe 9 to the pump unit 14. The check valve 15 has a metal reed valve 63 of a leaf spring, which opens a passage by the pressure of the secondary air discharged from the pump unit 14. A numeral 64 is a limiter for restricting a maximum opening degree of the reed valve 63.

The check valve 15, as the case may be, can not be operated in a normal operational condition, depending on or due to pulsation of the exhaust gas or amount of the exhaust gas, and the exhaust gas may possibly flow through the check valve 15 to the pump unit 14 in such a case.

The check valve 15 is likely to be affected by the heat from the exhaust gas from the engine. The pump unit 14 has such parts which are less resistive against the heat, such as the diaphragm 46. Accordingly, the pump unit 14 is arranged at such a position separated from the exhaust pipe 9 and the check valve 15. The first pipe 16 for sending the secondary air from the pump unit 14 to the check valve 15 is designed to be relatively long, so that the heat of the exhaust gas may not be easily transferred to the pump unit 14.

(Operation of Sending the Secondary Air)

When the operational condition for facilitating the warm-up of the catalyst 7 during the cold start period is met, the ECU 37 controls to supply the electric power to the relay coil of the relay 35 and the linear solenoid 53a of the pressure control device 53. The blower 31 is rotated to discharge the air from the discharge port 51, and the communication port 52 is opened so that the pressurized air from the blower 31 is supplied into the pressure chamber 44.

As soon as the electric air pump 12 starts its operation, the pressure in the pressure chamber 44 is increased to displace the diaphragm 46 in the leftward direction in FIG. 2. Then the movement of the diaphragm 46 is transmitted to the valve body 43 via the shaft 48, to open the opening (the outlet port) 42 of the valve device 13.

The secondary air is forcibly supplied into the exhaust pipe 9 through the opening 42, the first pipe 16, the check valve 15 and the second pipe 17, so that the warm-up operation for the catalyst 7 is facilitated.

When the ECU 37 detects the opening of the valve device 13 by the pressure sensor 62, or when a certain time passes by from the start of the operation of the pump unit 14, the supply of the electric power to the linear solenoid 53a of the pressure control valve device 53 is cut off to close the communication port 52. The pressure in the pressure chamber 44 is kept at the high pressure, so that the valve device 13 keeps its valve-opened condition.

When the temperature of the catalyst 7 is increased, the ECU 37 controls to cut off the electric power supply to the relay coil of the relay 35, and the operation of the electric motor 30 is stopped. Then, the discharge pressure of the blower 31 is decreased. In this operation, the ECU 37 controls to continuously supply the electric power to the linear solenoid 53a for a predetermined period, to keep the opening condition of the communication port 52 for the predetermined period.

The pressure chamber 44 is communicated with the inside passage 61, the pressure of which is decreased, so that the pressure in the pressure chamber is likewise decreased. Then, the diaphragm 46 as well as the valve body 43 is moved by the spring force of the springs 49 and 50 in the rightward direction in FIG. 2, to close the opening (the outlet port) 42 of the valve device 13.

### Effects of the First Embodiment

According to the above described pump unit 14 for the secondary air supply system, the communication port 52 is provided for guiding the pressurized air from the electric air pump 12 into the pressure chamber 44 of the diaphragm device 47, and the opening and closing of the communication port 52 is controlled by the pressure control device 53.

As a result, even when the electric air pump 12 is operated, the pressure of the pressure chamber 44 is not increased unless the communication port 52 is opened by the pressure control device 53. And thereby, the valve device 13 is kept closed.

The pressure of the pressure chamber 44 can be kept at a high pressure, when the communication port 52 is closed by the pressure control device 53 after the high pressure air is supplied from the electric air pump 12 into the pressure chamber 44. The valve-opened condition of the valve device 13 is, therefore, continued, independently from the operation of the electric air pump 12.

In the embodiment, when the electric air pump 12 is operated and the valve device 13 is opened, the electric power supply to the pressure control device 53 is cut off by the ECU 37, to close the communication port 52 so that the high pressure in the pressure chamber 44 is maintained and the opened condition of the valve device 13 is likewise maintained. As a result, electric power consumption for the pressure control device 53 during the period of opening of the valve device 13 can be suppressed.

In the pump unit 14 of the above embodiment, the pressure of the pressure chamber 44 can be quickly increased (or decreased) in response to the operation of the electric air pump 12, because the pressure chamber 44 is arranged at the position close to the discharge port 51 of the electric air pump 12, and the volume of the inside passage 61 is designed to be small. The quick response for opening or closing the valve device 13 is achieved, and the opening and closing operation of the valve device 13 can be surely performed even when the secondary air supply system is used at a high altitude, at which the ambient pressure is lower.

The pressure sensor 62 is integrally provided in the pressure control device 53, so that those two elements can be assembled to the casings 23 and 24 at one fixing portion. Furthermore, an electric connector 65 can be commonly used for those two elements.

A self diagnosis can be performed by detecting, by the pressure sensor 62, the pressure in the inside passage 61 from the discharge port 51 of the electric air pump 12 to the opening 42, in respect of the operational condition of the electric air pump 12 and the valve device 13.

Additionally, the high response for the pressure detection at the discharge port 51 of the electric air pump 12 can be achieved due to the small volume of the inside passage 61.

Furthermore, in the pump unit 14 of the above embodiment, the valve body 43, the shaft 48, the diaphragm device 47, the blower 31 and the electric motor 30 are coaxially and closely arranged and integrally assembled together. The pump unit 14 can be made in a simple structure and in a small size, so that a process for mounting the pump unit into a vehicle can be improved, number of parts can be reduced, and thereby a number of man power for assembling the pump unit 14 can be reduced.

The valve body 43 of the valve device 13 is arranged to be seated on the seat of the opening 42 at the downstream side of the air pump 12. The valve body 43 is not opened by the pressure of the exhaust gas, even if the pressure of the exhaust gas is applied to the valve body 43 at the downstream side of the air pump during the valve is closed, because the pressure of the exhaust gas is applied in the direction of closing the valve body 43. Even in the case that any problem occurred at the check valve 15, the exhaust gas is prevented from flowing into the electric air pump 12.

The valve body 43 is mechanically operated by the diaphragm device 47. When compared with such a structure in which the valve body 43 is operated by an electromagnetic actuator, any control relay (an IC relay, etc.) is not necessary in the present invention and thereby no electric power is necessary.

### Second Embodiment

In the above first embodiment, the two-way valve of the normally closed type is used as the example for the pressure control device 53.

A three-way valve can be used as the pressure control device 53 for controlling the pressure of the pressure chamber 44, wherein the three-way valve controls the opening degree of two air passages, one of which is the air passage between the pressure chamber 44 and the inside passage 61 and the other of which is the passage between the pressure chamber 44 and the outside (the ambient air) of the pump unit 14. The three-way valve is controlled by the ECU 37 in a duty-control manner, so that the pressure of the pressure chamber 44 can be controlled at the desired value.

According to such arrangement, the opening degree of the opening 42 can be freely controlled by varying the pressure in the pressure chamber 44 during the operation of the electric air pump 12.

(Other Modifications)

In the above first embodiment, the power supply control to the electric motor 30 is carried out by the mechanical relay 35. However, an IC-relay having a semi-conductor switching device can be used, so that a high-speed switching operation can be achieved by PWM control for the electric motor 30. The amount of the discharge air of the electric air pump 12 can be varied with the PWM control in accordance with a demand of the secondary air supply system. The heat may be generated at the IC relay. The IC relay can be cooled down by the air flowing in the air duct 33, when the IC relay is arranged in the air duct 33.

In the above embodiment, the shaft 48 is coaxially arranged with the rotational shaft 56 of the electric motor 30. The shaft can be, needless to say, arranged at a different position.

The electric air pump 12 and the valve device 13 can be separately formed and operatively connected with each other by means of ducts.

Gears, cams and rings can be used for transmitting the movement of the diaphragm 46 to the valve body 43, instead of the shaft 48.

The diaphragm 46 can be replace by bellows or any other moving device.

An AC motor can be used in place of the DC motor 30.

The present invention can be used to any other system other than the secondary air supply system.

1. An air supply pump system comprising:
an air pump for compressing and discharging air;
a valve device having a pressure chamber into which the compressed high-pressure air from the air pump is introduced, a movable element moving in response to the pressure in the pressure chamber, and a valve body operatively connected to the movable element for controlling an opening or closing of an outlet port of the valve device;
a communication passage for introducing the compressed high-pressure air from the air pump into the pressure chamber;
a pressure control device having a pressure control valve and an electrical actuator, and provided in the communication passage for controlling the pressure in the pressure chamber by controlling an opening and closing of the communication passage; and
a control unit for controlling an operation of the electrical actuator in accordance with an operational condition of the air supply pump system.

2. An air supply pump system according to claim 1, wherein
the pressure control valve comprises a two-way valve for opening and closing the communication passage.

3. An air supply pump system according to claim 1, wherein
the pressure control valve comprises a three-way valve for controlling the pressure in the pressure chamber.

4. An air supply pump system according to claim 1, wherein
the air pump comprises an electric motor and a blower.

5. An air supply pump system according to claim 1, wherein
the valve body is arranged adjacent to the moving element, and
the volume of an inside passage connecting a discharge port of the air pump with the outlet port is designed to be small.

6. An air supply pump system according to claim 1, wherein
the pressure control device comprises a pressure sensor for detecting the pressure of the air in an inside passage connecting a discharge port of the air pump with the outlet port.

7. An air supply pump system according to claim 1, wherein
the movable element comprises;
a diaphragm displaced by a pressure difference between the pressure in the pressure chamber and the ambient pressure; and
a transmitting element for transmitting the displacement of the diaphragm to the valve body.

8. An air supply pump system according to claim 7, wherein
the transmitting element is a shaft connecting the diaphragm with the valve body,
the shaft is coaxially arranged with a rotational shaft of the air pump on a discharge side of the air pump, and
the air pump and the valve device are integrally formed.

9. An air supply pump system according to claim 1, wherein
the air supply pump system is used as a secondary air supply system for an internal combustion engine,
the air supply pump system supplies air into an exhaust pipe for the engine at an upstream side of a catalyst, and
the amount of the air to be supplied into the exhaust pipe is controlled by the valve device.

10. An air supply pump system according to claim 9, wherein
the valve body is seated on a valve seat of the outlet port at a downstream side of the air pump.
